(19) United States
(12) Patent Application Publication
(10) Pub. No.: US 2026/0009493 A1
(43) Pub. Date: Jan. 8, 2026

(54) VENTURI-BASED FLOW SYSTEM FOR SCALE INHIBITION

(71) Applicant: Saudi Arabian Oil Company, Dhahran (SA)

(72) Inventors: Qiwei Wang, Dhahran (SA); Husain H. Bar, Dammam (SA)

(21) Appl. No.: 18/764,813

(22) Filed: Jul. 5, 2024

(51) Int. Cl. F16L 58/00; B08B 9/027; C09K 8/528

(52) U.S. Cl. CPC F16L 58/00; B08B 9/027; C09K 8/528

(57) ABSTRACT

This technology relates to a system and method of preventing scale formation in a pipeline. The method includes the coupling of a venturi tube on a primary flowline. During fluid flow through the primary flowline, the fluid encounters a venturi tube on its path. The venturi tube creates a pressure difference which diverts a portion of the flowing fluid into a chemical holding tank as a diverted side stream. The chemical holding tank includes a scale inhibitor. When the diverted side stream contacts the scale inhibitor in the chemical holding tank, the active scale inhibition compounds are released into the diverted side stream. The diverted side stream laden with scale inhibitor compounds are merged into the primary flowline through a return line. This leads to the introduction of scale inhibitors in the venturi tube and in the primary flowline downstream of the venturi tube.

### TECHNICAL FIELD

This disclosure relates to a flow system for inhibiting scale formation in a flowline or pipeline through which fluids flow.

### BACKGROUND

Natural water and produced water in oil and gas fields contain high concentrations of calcium, sulfides, sulphates, and bicarbonates. Changes in physical conditions, such as pressure and temperature, can shift the chemical equilibrium that leads to water becoming supersaturated with calcium carbonate (CaCO₃) and calcium sulfate (CaSO₄). Such shift in chemical equilibrium can result in the formation of scale in flow equipment that carry such fluids. Scale deposits can restrict hydrocarbon flow and damage equipment such as heat exchangers, cooling systems, and membrane filtration units. Such damage reduces productivity and can interrupt operational processes due to solid formation. Heavy scale deposition can result in complete production well shutdown. Scaling rate increases with the increase of water production in mature wells. Cleaning up scale can consume capital, operating, and maintenance cost, unless managed effectively.

### SUMMARY

An implementation described here provides a method and system for scale inhibition at oil and gas facilities.

### BRIEF DESCRIPTION OF DRAWINGS

FIG. 1 is a schematic drawing of an exemplary inhibitor treatment system that includes a venturi tube section.

FIG. 2 is a schematic drawing of the venturi tube section of the inhibitor treatment system of FIG. 1.

FIG. 3 is a schematic drawing of the scale inhibition system in an example oil and gas facility.

FIG. 4 is a flow chart of an example method of scale inhibition using a venturi tube in an oil and gas facility.

### DETAILED DESCRIPTION

Many approaches have been deployed to control scale formation, with threshold scale inhibitor usage being the most cost-effective. The threshold scale inhibitors are applied by either batch treatment or continuous injection. Batch treatment includes downhole placement by squeeze treatment or an encapsulated scale inhibitor. In scale inhibitor squeeze (SIS) treatment, the inhibitor product is pumped into the reservoir under high pressure and part of the pumped inhibitor product is retained by reservoir rocks by either adsorption or precipitation processes. During production, the retained inhibitors are gradually released into the produced water. With SIS treatment, there is limited control on the scale inhibitor concentration and repeated treatment is often required. Encapsulated scale inhibitors are used only for vertical wells with a rathole. In continuous injection, scale inhibitor product is dosed into the production stream by a metering pump, which requires power and extensive maintenance.

Scale inhibitor released into the produced water based on squeeze treatment and encapsulated inhibitor batch treatment is designed to provide scale inhibition for downhole equipment, which usually have less scaling due to low scaling tendency and short residence time of the produced water. The scale inhibitor concentration in the produced water is insufficient to prevent scale formation when the produced water travels to the surface.

This disclosure describes the implementation of a system and a method that uses an encapsulated scale inhibitor to provide sufficient inhibitor concentration continuously at a wellhead or at surface facilities. In implementations described here, a venturi tube fluidically coupled to the primary flowline diverts a side stream of the produced water stream into a holding tank. The holding tank includes an encapsulated scale inhibitor. The diverted produced water enters the holding tank and releases the active scale inhibition compounds from the encapsulated scale inhibitor. The diverted produced water stream that includes the active scale inhibition compounds is merged with the produced fluid in the primary flowline. This helps to prevent scale buildup in the system downstream of the venturi tube. A detailed explanation of the figures is provided in the following paragraphs. The implementations described here are applicable to an aqueous stream received from other sources as well. The techniques described here can generally be used to inhibit scale formation in any system through which fluid streams flow, such as sea water, brine, treated water, boiler feed water, or waste water discharges from water filters. The fluid stream can include any fluid that causes scaling in flowlines.

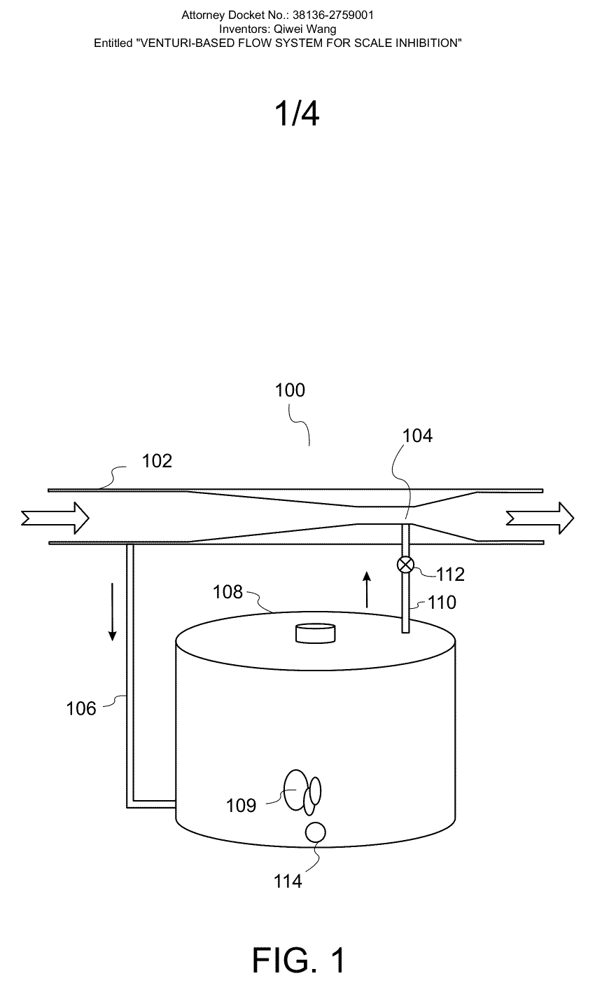

FIG. 1 is a schematic drawing of an inhibitor treatment system 100. The system includes a primary flowline 102 which receives, for example, a produced water stream from a high pressure production trap (HPPT) and a low pressure production trap (LPPT). A venturi tube 104 is fluidically coupled to the primary flowline 102. A flowline 106 is fluidically coupled to the primary flowline 102 and to a chemical holding tank 108. The chemical holding tank 108 includes a scale inhibitor 109. A return flowline 110 is fluidically coupled to the chemical holding tank 108 and the primary flowline 102. A valve 112 is installed on the return flowline 110. The following description gives details about the method of providing a continuous and adequate concentration of scale inhibitors to the flowing produced water stream in the primary flowline 102.

Hydrocarbons along with produced water flow from a wellhead to a production flowline during oil production. In the context of this disclosure, flowline or pipeline mean an elongated hollow tube through which fluids such as produced water streams can flow. A high pressure production trap (HPPT) and a low pressure production trap (LPPT) separate the flowing hydrocarbons and produced water into crude oil, produced water, and gas. In some implementations, the produced water stream from the HPPT and LPPT flows through a primary flowline 102 which is fluidically coupled to the HPPT and LPPT (not shown). In some implementations, the pressure of the produced water stream in the primary flowline 102 ranges between 200-600 psi. In some implementations, the water stream can be received by the primary flowline 102 from other sources. For example, the water stream sources can include waste discharge from water filters, brine discharge, boiler feed water, mining water discharge, sea water, or water by-product from chemical plants. As the produced stream flows through the primary flowline 102, it encounters the venturi tube 104.

The venturi tube 104, which is fluidically coupled to the primary flowline 102, has an inlet and an outlet with a cross-sectional area. In between the inlet and outlet cross-sectional areas, the venturi tube 104 has a constricted path that has a cross-sectional area smaller than the inlet and outlet cross-sectional area. The constricted path is formed by increasing a wall thickness of the venturi tube at the constricted path compared to the wall thickness in other portions of the venturi tube. When the produced water stream flows through the venturi tube 104, the produced water stream experiences a venturi effect. A venturi effect is a drop in fluid pressure when a fluid flows through a constricted path. During flow through a constricted path, the fluid velocity increases and the pressure drops. This creates a pressure difference (ΔP) across the venturi tube’s inlet and outlet. The ΔP is determined by the venturi tube design, such as angle and length, and the production system parameters such as flowline diameter and production rate. The ΔP across the venturi tube’s 104 inlet and outlet causes a portion of the produced water stream to be diverted through the flowline 106 into the chemical holding tank 108.The other portion of the produced water stream flows through the venturi tube 104 without being diverted as a side stream. The flow rate of the diverted portion of the produced water stream is controlled by valve 112.

The chemical holding tank 108 includes a scale inhibitor 109. In some implementations, the scale inhibitor 109 includes an encapsulated scale inhibitor or a solid scale inhibitor. When the diverted stream is in contact with the encapsulated scale inhibitor or solid scale inhibitor in the chemical holding tank 108, the active inhibition compounds in the encapsulated scale inhibitor diffuse into the diverted produced water stream or the solid scale inhibitor is dissolved slowly into the diverted produced water stream. The chemical holding tank 108 is maintained at a temperature between 100-200°F.

Examples of scale inhibitor products include phosphonate esters, phosphonates, polymeric compounds, or a combination of two or more different types of scale inhibitors. Phosphate ester inhibitors include triethanolamine phosphate ester, hydroxyamine phosphate ester, or polyhydric alcohol phosphate ester.

Phosphonate inhibitors include all organic compounds with one or more ortho-phosphate functional groups. These include, but not limited to, amino trimethylene phosphonate, bishexamethylene triamine pentamethylene phosphonate, hexamethylenediamine tetramethylene phosphonate, diethylenetriamine pentamethylene phosphonate, ethylene diamine tetramethylene phosphonate, 1-hydroxyethylidene-1,1- diphosphonate, polyamino polyether methylene phosphonate, and 2-phosphonobutane-1,2,4-tricarboxylic acid.

Polymeric scale inhibitors include polyacrylate or polymaleic functional groups, such as polyacrylate, polymaleic acid homopolymer, their sulfonated forms, or other co- or multi-polymers based on these functional groups. The appropriate inhibitor chemistry is determined in lab studies under simulated field conditions. The various lab test methods include dynamic tube blocking test, static bottle test, and kinetic turbidity test. Temperature and pressure can be a factor to determine the efficiency of the scale inhibitor. For a given producing well, the change in temperature near the wellhead is small over time.

In some implementations, the scale inhibitor includes a solid scale inhibitor. In some implementations, the scale inhibitor is in the form of capsules where a liquid scale inhibitor is enclosed by a permeable or semi-permeable polymeric material, also known as encapsulated scale inhibitors. In some implementations, the scale inhibitor is a low soluble precipitate formed by reacting a liquid scale inhibitor with multi-valence cations, such as alkaline earth metal ions. The alkaline earth metal can include calcium, magnesium, barium, or strontium. In some implementations, heavy metal ions such as iron, nickel, copper, or zinc are used, instead of alkaline earth metals. In some implementations, the scale inhibitor products are prepared by adsorbing scale inhibitor compounds on porous solid materials. The porous solid materials can have a high surface area such as activated carbon, zeolite, cluster of nanoparticles, carbon nanotubes, or microporous thin films.

The solid scale inhibitor or the encapsulated scale inhibitor has a residence time in the chemical holding tank 108. A mean residence time of the scale inhibitor can be calculated as the volume of the chemical holding tank divided by the flow rate of the diverted produced water stream. The mean residence time can be changed by adjusting the flow rate of the diverted produced water stream using valve 112. In addition to adjusting the flow rate, the venturi tube 104 design also determines the flow rate of the diverted produced water stream.

Low flow rates of the diverted produced water stream will have a longer residence time in the chemical holding tank 108. This leads to a higher scale inhibitor concentration in the diverted produced water stream. However, the longer residence time will dilute the scale inhibitor concentration when the diverted produced water stream laden with scale inhibitor particles returns to the primary flowline 102. High flow rates will have a shorter residence time in the chemical holding tank 108. This leads to a lower scale inhibitor concentration in the diverted produced water stream. However, the shorter residence time will reduce the dilution of the scale inhibitor concentration in the return flowline 110. An optimal residence time is beneficial for having sufficient scale inhibitor concentration in the diverted produced water stream in the return flowline 110.

The diverted produced water stream laden with scale inhibitor particles returns via the return flowline 110 to the primary flowline 102. In some implementations, the return flowline has a valve 112 which is used to change (adjust) the flowrate of the diverted produced water stream. In some implementations, the valve 112 is automated. In other implementations, the valve 112 is manual. The valve 112 includes a flow regulator valve which regulates the flow rate of the diverted produced water stream. Adjusting the flowrate of the diverted produced water stream, in turn adjusts the concentration of the scale inhibitor particle concentration in the return flowline 110.

When the diverted produced water stream laden with scale inhibitor particles returns to the primary flowline 102, the scale inhibitor particle concentration in the produced water stream, downstream of the venturi tube, is measured by a sampling unit. The sampling unit includes a spectrophotometer or an inductively coupled plasma (ICP) unit. When the scale inhibitor concentration falls below the pre-determined threshold level, scale inhibitor product in the chemical holding tank 108 will be replaced and a new scale inhibitor product will be charged to the chemical holding tank 108. An opening 114, on the chemical holding tank 108 will be used to remove the depleted scale inhibitor product.

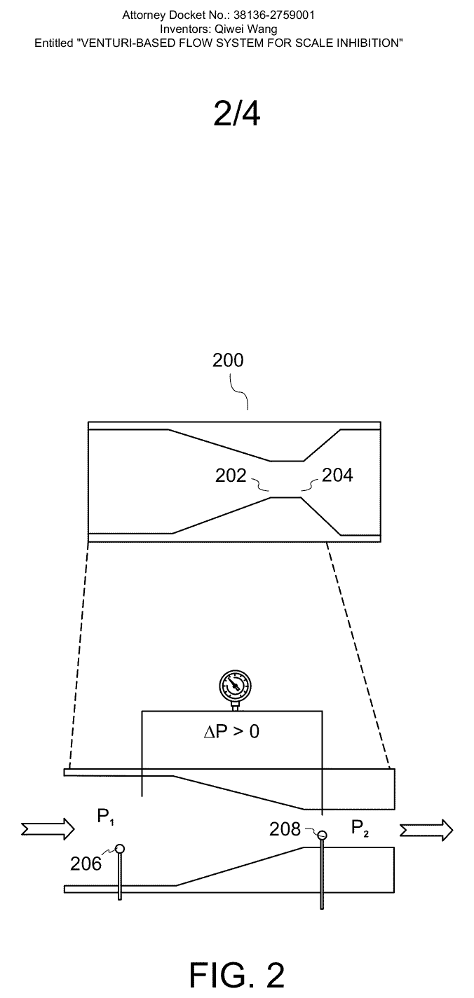

FIG. 2 is a schematic drawing of the venturi tube section of the inhibitor treatment system of FIG. 1. The venturi tube 200 has an inlet 202 and an outlet 204. The venturi tube 200 has an upstream cross sectional area 206 and gradually converges to a downstream constricted cross sectional area 208. The venturi tube 200 gradually diverges after the cross sectional area 208 to match the cross sectional area of 206. The upstream cross sectional area 206 is greater than the downstream constricted cross sectional area 208. When the produced water stream flows through the upstream cross sectional area, the flowrate is low, and the pressure P1 is high. In comparison, when the produced water stream flows through the downstream cross sectional area 208, the flow rate is high and the pressure P2 is low. The difference in pressure P1 and P2 causes a portion of the produced water stream to divert as a side stream through a flowline into a chemical holding tank as described in FIG. 1.

At the constricted cross sectional area 208, the flowing produced water stream experiences a turbulent flow due to the higher flow rate. After the constricted cross sectional area 208, the venturi tube gradually diverges. At the exact junction where the pressure is lowest (P2) and when it rises just above P2, a vacuum is formed. The vacuum draws in the diverted produced water stream laden with scale inhibitor particles from a flowline fluidically connected to it (refer to flowline 110 in FIG. 1). into the constricted region of the venturi tube 200 at P2. This implementation ensures that no scale is formed in the constricted region.

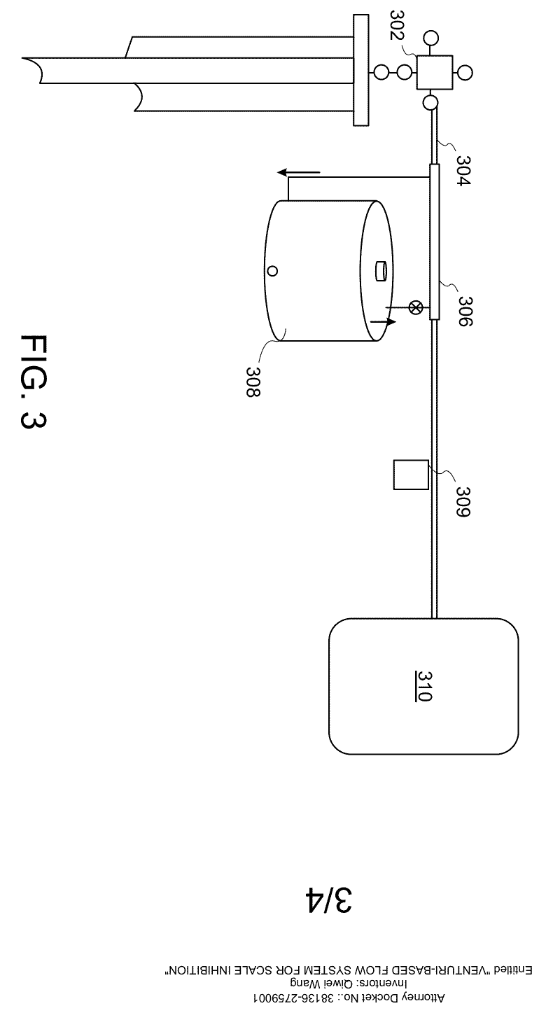

FIG. 3 is a schematic drawing of the scale inhibition system in an example oil and gas facility. During oil production, large volumes of produced water is obtained as a by-product. The produced water is separated from the oil in a HPPT and LPPT unit 302 which is placed downstream of an oil production wellhead. The produced water flows through the primary flowline 304. During flow, the produced water encounters a venturi tube 306 along the path of the primary flowline 304. The venturi tube 306 has an upstream inlet cross-sectional area and a downstream constricted flow passage. The downstream constricted flow passage has a cross-sectional area smaller than the upstream inlet cross-sectional area. The difference in cross-sectional areas causes a difference in pressure during flow. The upstream cross-sectional area causes the produced water to have a low velocity and a high pressure. Whereas the constricted flow passage in the venturi tube 306 causes the produced water to experience an increase in flow velocity and a drop in pressure. A pressure difference created across the venturi tube 306 diverts a portion of the produced water through a secondary flowline into a chemical holding tank 308 (refer to FIG.1 and FIG.2). The secondary flowline is fluidically coupled to the primary flowline and the chemical holding tank 308.

The chemical holding tank 308 includes scale inhibitors. In some implementations, the scale inhibitors can include an encapsulated scale inhibitor. The encapsulated scale inhibitor can include a liquid or a solid form. In the chemical holding tank, the diverted side stream of the produced water contacts the scale inhibitor. During contact, the scale inhibitor compounds are diffused into the diverted side stream of the produced water. The diverted side stream that includes the scale inhibitor compounds is merged through a return flow line back into the primary flowline 304.

As the diverted side stream laden with scale inhibitor flows through the primary flowline 304, it merges with the incoming produced water stream in the primary flowline 304. Along the flow path of the primary flowline 304 and downstream of the venturi tube 306, a sampling unit 309 is installed. The sampling unit 309 includes sampling techniques such as ICP, spectrophotometry methods, and wet chemistry to measure the scale inhibitor concentration in the produced water stream flowing downstream of the venturi tube 306. The sampling method ensures that sufficient scale inhibitor concentration is present to prevent scaling of the downstream equipment. Sampling can be done at regular intervals such as every hour or once every day. The produced water that includes sufficient scale inhibitor concentration flows towards the water oil separator 310. This helps to prevent scaling of the downstream flowlines and equipment such as heat exchangers, boiler system, and pumps.

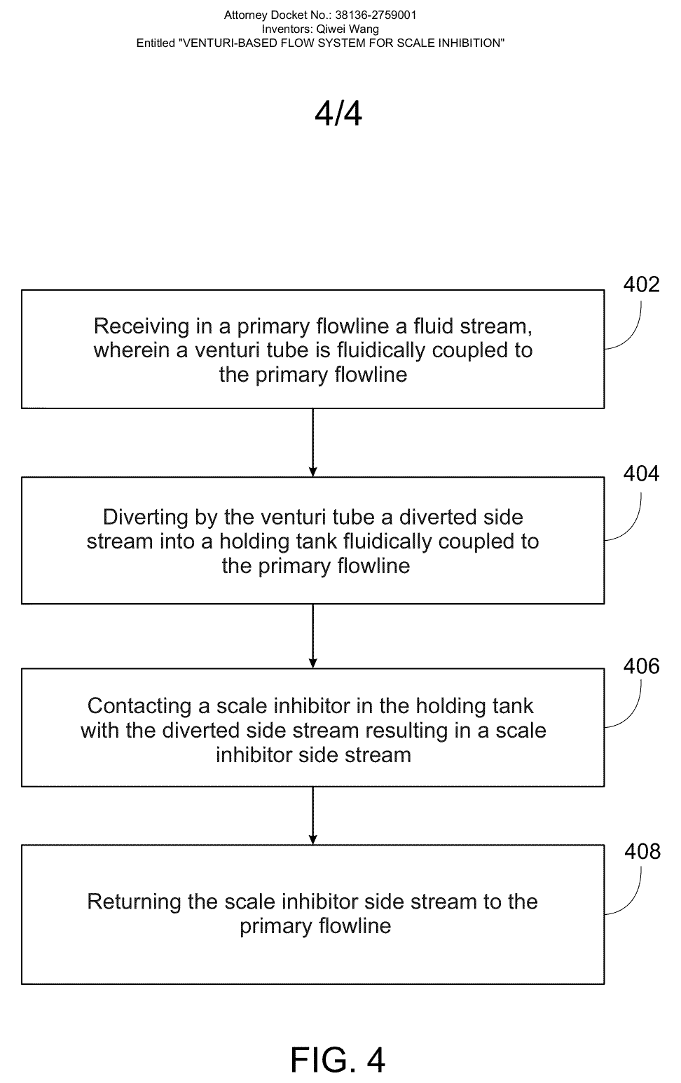

FIG. 4 is a flow chart of an example method of scale inhibition using a venturi tube in an oil and gas facility. At block 402, a primary flowline receives a fluid from the HPPT and LPPT. A venturi tube is fluidically coupled to the primary flowline. The venturi tube has an upstream cross-sectional area where velocity is low, but pressure is high. The venturi tube has a downstream constricted cross-sectional area where velocity is high, but pressure is low. As the fluid flows from the upstream cross-sectional area to the downstream constricted cross-sectional area a pressure difference is developed across the venturi tube.

At block 404, the pressure difference developed across the venturi tube diverts a portion of the produced water stream in to a holding tank through a secondary flowline, resulting in a diverted side stream. The holding tank is fluidically coupled to the secondary flowline. At block 406, the diverted side stream contacts a scale inhibitor in the holding tank. This results in a scale inhibitor side stream. In some implementations, the scale inhibitor can include a solid scale inhibitor or an encapsulated scale inhibitor with a solid or liquid active inhibitor compound. Scale inhibitors can include phosphonate esters, phosphonates, and polymeric compounds, or a combination of two or more different types of inhibitors compounds.

At block 408, the scale inhibitor side stream returns to the primary flowline through a return flowline. The return flowline is fluidically coupled to the holding tank and the primary flowline. The return flowline includes a valve that is used to control the flowrate of the scale inhibitor side stream, which in turn controls the concentration of the scale inhibitor. This ensures that sufficient scale inhibitor concentration is available in the merging scale inhibitor side stream. This protects the flowline, system, and equipment downstream of the venturi tube from scale formation.

### EXAMPLES

Certain aspects of the subject matter described here can be implemented as a method for inhibiting scale in a pipeline. A primary flowline, which is fluidically coupled to a venturi tube receives a fluid stream. The venturi tube diverts a portion of the fluid stream as a diverted side stream into a holding tank. The holding tank is fluidically coupled to the primary flowline and includes scale inhibitors to reduce scaling in the primary flowline. The diverted side stream contacts the scale inhibitors in the holding tank, resulting in a scale inhibitor side stream. The scale inhibitor side stream is returned to the primary flowline at the location of the venturi tube via a secondary flowline. The secondary flowline is fluidically coupled to the primary flowline and the holding tank.

An aspect combinable with any other aspect includes the following features. The venturi tube causes a pressure difference in the fluid stream. In response to the pressure difference, a portion of the fluid stream is diverted as the diverted side stream into the holding tank. The pressure difference depends on the flowrate of the produced water stream through the primary flowline. Further, the pressure difference depends on a first cross-sectional area at an inlet of the venturi tube and a second cross-sectional area of the venturi tube. The second cross-sectional area is downstream of the first cross sectional area and smaller than the first cross-sectional area.

An aspect combinable with any other aspect includes the following features. The secondary flowline includes a valve to adjust the flow rate of the diverted side stream into the holding tank.

An aspect combinable with any other aspect includes the following features. Adjusting the valve on the secondary flowline results in changing the concentration of the scale inhibitor in the scale inhibitor side stream

An aspect combinable with any other aspect includes the following features. The scale inhibitor includes phosphonate esters, phosphonates, polymeric compounds, or a combination of them.

An aspect combinable with any other aspect includes the following features. The scale inhibitor includes an encapsulated scale inhibitor or a solid scale inhibitor.

An aspect combinable with any other aspect includes the following features. An active scale inhibitor compound is released into the diverted side stream in response to contacting the encapsulated scale inhibitor or the solid scale inhibitor.

An aspect combinable with any other aspect includes the following features. The concentration of the scale inhibitor is measured across the primary flowline, downstream of the venturi tube.

An aspect combinable with any other aspect includes the following features. The scale inhibitors in the holding tank are replaced in response to the concentration of the scale inhibitors across the primary flowline falling below a pre-determined level.

Certain aspects of the subject matter described here can be implemented as a system for scale inhibition in an oil and gas facility. The system includes a primary flowline configured to receive a produced water stream from a HPPT and a LPPT. The primary flowline is fluidically coupled to a venturi tube. A holding tank, fluidically coupled to the primary flowline includes a scale inhibitor. The holding tank is configured to receive a portion of the produced water stream, as a diverted side stream, from the primary flowline. A return flowline is fluidically coupled to the holding tank and the primary flowline. The return flowline is configured to flow the diverted side stream that includes the scale inhibitor back into the primary flowline. A valve, which is fluidically coupled to the return flowline is configured to change the flow rate of the diverted side stream.

An aspect combinable with any other aspect includes the following features. The pressure difference across the venturi tube causes the diversion of the diverted side stream of the produced water stream into the holding tank.

An aspect combinable with any other aspect includes the following features. The scale inhibitor includes phosphonate esters, phosphonates, polymeric compounds, or a combination of them.

An aspect combinable with any other aspect includes the following features. The scale inhibitors include triethanolamine phosphate ester, hydroxyamine phosphate ester, polyhydric alcohol phosphate ester, amino trimethylene phosphonate, bishexamethylene triamine pentamethylene phosphonate, hexamethylenediamine tetramethylene phosphonate, diethylenetriamine pentamethylene phosphonate, ethylene diamine tetramethylene phosphonate, 1-hydroxyethylidene-1,1- diphosphonate, polyamino polyether methylene phosphonate, and 2-phosphonobutane-1,2,4-tricarboxylic acid, polyacrylate homopolymer, polymaleic acid homopolymer, or sulfonated forms of polyacrylate homopolymers or polymaleic acid homopolymers.

An aspect combinable with any other aspect includes the following features. The scale inhibitor includes an encapsulated scale inhibitor or a solid scale inhibitor.

An aspect combinable with any other aspect includes the following features. The valve on the return flowline is used to adjust the concentration of the scale inhibitor in the diverted side stream.

An aspect combinable with any other aspect includes the following features. A sampling unit downstream of the venturi tube is used to measure the concentration of the scale inhibitor in the primary flowline.

An aspect combinable with any other aspect includes the following features. The holding tank includes an opening to replace the scale inhibitor in response to the concentration of the scale inhibitor in the primary flowline falling below a pre-determined level.

Certain aspects of the subject matter described here can be implemented as a method for treating produced water in an oil and gas surface facility. A main flowline receives a produced water stream from a HPPT and LPPT. The produced water stream is flowed through a venturi tube which is fluidically coupled to the main flowline. The venturi tube causes a pressure difference. The pressure difference across the venturi tube diverts a portion of the produced water stream into a vessel that includes an active treatment agent. The active treatment agent is released into the portion of the produced water stream, resulting in a diverted produced water stream that includes the active treatment agent. The diverted produced water stream that includes the active treatment agent is merged into the main flowline at the location of the venturi tube, through a return flowline, by regulating a valve on the return flowline. The return flowline is fluidically coupled to the main flowline and the vessel.

An aspect combinable with any other aspect includes the following features. The concentration of the active treatment agent in the diverted produced water stream is adjusted by regulating the valve on the return flowline. This further results in adjusting the concentration of the active treatment agent in the produced water stream downstream of the venturi tube.

An aspect combinable with any other aspect includes the following features. The active treatment agent includes a scale inhibitor, a corrosion inhibitor, a demulsifier, a hydrogen sulfide scavenger, an oxygen scavenger, a pH adjustment chemical, a biocide, or a combination of them.

Other implementations are also within the scope of the following claims.

1. A method of inhibiting scale formation in a pipeline, the method comprising:
receiving, in a primary flowline, a fluid stream, wherein a venturi tube is fluidically coupled to the primary flowline;
diverting, by the venturi tube a portion of the fluid stream as a diverted side stream into a holding tank fluidically coupled to the primary flowline, wherein the holding tank comprises scale inhibitors configured to reduce scaling in the primary flowline;
contacting the scale inhibitors in the holding tank with the diverted side stream, resulting in a scale inhibitor side stream; and
returning the scale inhibitor side stream to the primary flowline at the location of the venturi tube through a secondary flowline fluidically coupled to the primary flowline and the holding tank.

2. The method of claim 1, wherein the venturi tube causes a pressure difference in the fluid stream, wherein the portion of the fluid stream is diverted as the diverted side stream into the holding tank in response to the pressure difference, wherein the pressure difference is based on:
a flowrate of the produced water stream through the primary flowline;
a first cross-sectional area at an inlet of the venturi tube; and
a second cross-sectional area of the venturi tube, wherein the second cross-sectional area is downstream of the first cross sectional area and smaller than the first cross-sectional area.

3. The method of claim 1, further comprising adjusting a valve on the secondary flowline to adjust a flow rate of the diverted side stream into the holding tank.

4. The method of claim 3, wherein adjusting the valve on the secondary flowline results in changing a concentration of the scale inhibitor in the scale inhibitor side stream.

5. The method of claim 1, wherein the scale inhibitors comprise phosphonate esters, phosphonates, polymeric compounds, or a combination thereof.

6. The method of claim 5, wherein the scale inhibitors comprise an encapsulated scale inhibitor or a solid scale inhibitor.

7. The method of claim 6, further comprising releasing an active scale inhibitor compound into the diverted side stream in response to contacting the encapsulated scale inhibitor or the solid scale inhibitor.

8. The method of claim 1, further comprising measuring a concentration of the scale inhibitors across the primary flowline, downstream of the venturi tube.

9. The method of claim 8, further comprising replacing the scale inhibitors in the holding tank, in response to the concentration of the scale inhibitors across the primary flowline falling below a pre-determined level.

10. A system for scale inhibition in an oil and gas facility comprising:
a primary flowline configured to receive a produced water stream from a high pressure production trap (HPPT) and a low pressure production trap (LPPT);
a venturi tube fluidically coupled to the primary flowline;
a holding tank, comprising a scale inhibitor fluidically coupled to the primary flowline, wherein the holding tank is configured to receive a diverted side stream of the produced water stream from the primary flowline;
a return flowline, fluidically coupled to the holding tank and the primary flowline, wherein the return flowline is configured to flow the diverted side stream comprising the scale inhibitor back into the primary flowline; and
a valve fluidically coupled to the return flowline, wherein the valve is configured to change the flow rate of the diverted side stream.

11. The system of claim 10, wherein the pressure difference across the venturi tube causes the diversion of the diverted side stream of the produced water stream into the holding tank.

12. The system of claim 10, wherein the scale inhibitor comprises phosphonate esters, phosphonates, polymeric compounds, or a combination thereof.

13. The system of claim 12, wherein the scale inhibitor comprises triethanolamine phosphate ester, hydroxyamine phosphate ester, polyhydric alcohol phosphate ester, amino trimethylene phosphonate, bishexamethylene triamine pentamethylene phosphonate, hexamethylenediamine tetramethylene phosphonate, diethylenetriamine pentamethylene phosphonate, ethylene diamine tetramethylene phosphonate, 1-hydroxyethylidene-1,1- diphosphonate, polyamino polyether methylene phosphonate, and 2-phosphonobutane-1,2,4-tricarboxylic acid, polyacrylate homopolymer, polymaleic acid homopolymer, or sulfonated forms of polyacrylate homopolymers or polymaleic acid homopolymers.

14. The system of claim 12, wherein the scale inhibitor comprises an encapsulated scale inhibitor or a solid scale inhibitor.

15. The system of claim 10, wherein the valve on the return flowline is used to adjust a concentration of the scale inhibitor in the diverted side stream.

16. The system of claim 10, further comprises a sampling unit downstream of the venturi tube to measure a concentration of the scale inhibitor in the primary flowline.

17. The system of claim 10, wherein the holding tank further comprises an opening to replace the scale inhibitor in response to the concentration of the scale inhibitor in the primary flowline falling below a pre-determined level.

18. A method of treating produced water in an oil and gas surface facility, the method comprising:
receiving, in a main flowline, a produced water stream from a high pressure production trap (HPPT) and a low pressure production trap (LPPT);
flowing the produced water stream through a venturi tube fluidically coupled to the main flowline, wherein the venturi tube causes a pressure difference;
diverting, by the pressure difference across the venturi tube, a portion of the produced water stream into a vessel, wherein the vessel comprises an active treatment agent;
releasing the active treatment agent into the portion of the produced water stream, resulting in a diverted produced water stream comprising the active treatment agent; and
merging the diverted produced water stream at the location of the venturi tube through a return flowline fluidically coupled to the main flowline and the vessel, by regulating a valve on the return flowline.

19. The method of claim 18, wherein regulating the valve on the return flowline results in adjusting the concentration of the active treatment agent in the diverted produced water stream, which further comprises adjusting the concentration of the active treatment agent in the produced water stream downstream of the venturi tube.

20. The method of claim 19, wherein the active treatment agent comprises a scale inhibitor, a corrosion inhibitor, a demulsifier, a hydrogen sulfide scavenger, an oxygen scavenger, a pH adjustment chemical, a biocide, or a combination thereof.
